(19) United States
(12) Patent Application Publication
(10) Pub. No.: US 2017/0292191 A1
(43) Pub. Date: Oct. 12, 2017

(54) PROCESS FOR METALLIZING PLASTIC PARTS

(71) Applicant: Atotech Deutschland GmbH, Berlin (DE)

(72) Inventor: Alexandre BROUZES, Le Mesnil Saint Denis (FR)

(21) Appl. No.: 15/512,650

(22) PCT Filed: Oct. 13, 2015
(86) PCT No.: PCT/FR2015/052753

§ 371 Date: Mar. 20, 2017

(30) Foreign Application Priority Data
Nov. 4, 2014 (FR) 1460644

(51) Int. Cl. C23C 18/30; B29C 37/00; C23C 18/16; B29C 45/14; C25D 5/02; C25D 5/54

(52) U.S. Cl. CPC C23C 18/30; C25D 5/02; C25D 5/54; C23C 18/1603; C23C 18/1641; B29C 45/14; B29C 37/0025

(57) ABSTRACT

The present invention relates to a method for preventing the metallization of a support of at least one plastic part subjected to a metallization process, comprising the successive stages of oxidation of the surface of said part, of activation of the oxidized surface and of chemical and/or electrochemical deposition of metal on the activated surface, characterized in that it comprises a stage in which said support, before said oxidation stage, is brought into contact with an inhibiting solution comprising at least one specific metallization inhibitor. The invention also relates to a process for the selective metallization of a plastic part combined with a support, comprising bringing said part into contact with said inhibiting solution.

### TECHNICAL FIELD

The present invention relates to a method for preventing the metallization of a support of at least one plastic part subjected to a metallization process, comprising the successive stages of oxidation of the surface of said part, of activation of the oxidized surface and of chemical and/or electrochemical deposition of metal on the activated surface, characterized in that it comprises a stage in which said support, before said oxidation stage, is brought into contact with an inhibiting solution comprising at least one specific metallization inhibitor. The invention also relates to a process for the selective metallization of a plastic part combined with a support, comprising bringing said part into contact with said inhibiting solution.

### STATE OF THE ART

It is known to metallize plastics in order to confer on them specific esthetic, electrical or mechanical properties, for the purpose of use of these parts in the cosmetic, textiles, motor vehicle, aeronautical, electronic or electrical goods industry, for example. As the material to be metallized consists of a nonconducting polymer, industrial metallization processes comprise a sequence of stages intended to modify its surface in order to make possible the deposition of a metal coating which can be of varied nature. The aim of these stages is to provide optimum adhesion between the plastic substrate and the metal, in order to compensate for the accumulation of tensions at the plastic/metal interface, due in particular to the differences in coefficients of expansion, and to thus prevent possible delaminations.

The conventional metallization process thus comprises the dipping of the substrate successively in different baths, which are intended to carry out one or more chemical reactions at the surface of the sample. An example of a conventional sequence comprises the following stages:
preparation and cleaning of the sample, in order to improve its wettability in the following stage,
oxidizing attack on the sample (satin finishing), making it possible to create, at the surface, a microroughness which promotes the subsequent anchoring of the metal, typically using a bath of sulfuric acid at 40-70° C. containing chromium(VI),
neutralization of the excess chromium(VI) (which constitutes a poison for the catalyst used subsequently), for example by reduction to give chromium(III) using a reducing agent, such as hydrazine,
activation of the surface by deposition of a catalyst, generally a palladium/tin colloid formed of particles exhibiting a Pd/Sn core surrounded by a casing of Sn²⁺ ions neutralized by Cl⁻ ions: these particles diffuse into the microporosities present at the surface of the plastic and are chemically adsorbed therein, making it possible to catalyze the subsequent chemical deposition reaction,
acceleration by immersion of the sample in a bath, in particular of sulfuric acid, making it possible to oxidize the Sn(II) ions to give Sn(IV) ions and to release the adsorbed palladium particles,
chemical deposition of a metal layer by immersing the sample in an aqueous metal (for example copper or nickel) salt solution including a reducing agent, such as sodium hypophosphite, making possible the reduction of metal ions on the adsorbed Pd/Sn seeds and then over the entire surface of the sample,
thickening of the metal layer thus obtained, by the electrolytic route.

In addition, the above stages can each be followed by one or more intermediate stages of rinsing with water or using aqueous solutions. Furthermore, it should be noted that certain “direct plating” metallization processes do not comprise a chemical deposition stage.

In order to successively carry out these different treatments, the parts are placed on supports (or frames) which are moved from bath to bath, optionally while passing through intermediate rinsing stages. Typically, these supports consist of a metal core covered with plastic, for example PVC.

One of the problems encountered during the metallization of plastic parts on a support results from the simultaneous exposure of the plastic parts and of the supports to each of the stages, which can result in the metallization of the support. However, industrially, it is essential for the supports of parts not to metallize. This is because, if the support is metallized, it will be necessary to provide a subsequent stage of demetallization, which results in undesired costs and also in an excessive consumption of chemicals. Furthermore, the presence of metal on the supports leads to the appearance of metallization defects related to the supports having become conducting. This additional stage also negatively affects the productive output of the metallization process. In addition, it is generally carried out using hydrochloric acid, nitric acid or an electrolytic stripping in a basic medium. It is understood that some of these treatments may be toxic to the environment. Finally, when the support is metallized at the same time as the parts, it is not possible to correctly evaluate the amount of reactant to be applied as the degree of covering of the support is not known, which can result in the deposition of an excessively thin metal layer at the surface of the parts.

Furthermore, for technical or esthetic reasons, it may prove to be necessary to metallize some parts only partially, in particular when the parts comprise printed elements which must not be metallized. Several methods are currently used in order to do this. One of them, known as “two-shot injection molding”, consists of injecting two or more materials during the manufacture of the part, one of the materials metallizing less well than the other or others. Another method is based on the use of a resist paint which makes it possible to retain the covered parts in the raw state.

Currently, the commonest method used to prevent the metallization of the support consists in conditioning the support and the part to be metallized in the satin finishing bath. This is because, after a more or less lengthy time for attack by the satin finishing bath, the support, generally made of PVC, becomes rougher than the part to be metallized. This roughness makes it possible to absorb hexavalent chromium into the support, which hexavalent chromium constitutes a poison for the chemical metallization baths. Thus, the chromium acts, in the chemical deposition bath, as protecting agent for the support.

However, environmental and health constraints and new regulations are increasingly restricting the use of hexavalent chromium, which is toxic to man and to the environment, and are driving the installation of alternative metallization processes not involving chromium. It has thus been proposed to substitute solutions of permanganate ions for the conventional satin-finishing baths. In this context, it is thus advisable to also develop other techniques than “the poisoning” with hexavalent chromium, making it possible to avoid the metallization of the supports.

The patent application WO 2013/135862 describes a process for the metallization of plastic surfaces without chromium, in which the supports are treated with iodate ions, preferably at an advanced stage of the process, in order to prevent them from being metallized. It is understood that this treatment stage may affect the subsequent adhesion of the metal to the parts which, being integral with the supports, are treated simultaneously, indeed even prevent the metallization of the parts. In addition, in this process, the parts to be metallized are also subjected to a pretreatment using a glycol derivative, such as 2-(2-ethoxyethoxy)ethyl acetate or butoxyethanol. Apart from the fact that it increases the cost of the process and affects its environmental impact, this pretreatment is capable of also promoting the metallization of the support.

The need thus remains to have available a simple and inexpensive process not generating volatile organic compounds which makes it possible to selectively metallize nonconducting plastic parts, that is to say to prevent metallization of the support or of a portion of these parts, without affecting the quality or the mechanical strength of the metal deposit.

### SUMMARY OF THE INVENTION

Surprisingly, it has appeared to the applicant company that this need may be satisfied by using certain specific compounds as metallization inhibitors. In addition, these compounds can without distinction be used in metallization processes with or without chromium and in processes using or not using palladium in the stage of activation of the surface of the plastic parts.

The invention relates to a method for preventing the metallization of a support of at least one plastic part subjected to a metallization process, comprising the successive stages of oxidation of the surface of said part, of activation of the oxidized surface and of chemical and/or electrochemical deposition of metal on the activated surface, said method comprising a stage in which said support, before said oxidation stage, is brought into contact with an inhibiting solution comprising at least one metallization inhibitor chosen from sodium sulfite, thiourea, thiols, thioethers, compounds carrying at least one thiol and/or one thiazolyl group and their mixtures.

It also relates to a process for the selective metallization of a plastic part combined with a support, comprising the successive stages of oxidation of the surface of said part, of activation of the oxidized surface and of chemical and/or electrochemical deposition of metal on the activated surface, characterized in that it comprises a stage in which said part, before said oxidation stage, is brought into contact with an inhibiting solution comprising at least one metallization inhibitor chosen from sodium sulfite, thiourea, thiols, thioethers and their mixtures.

### DETAILED DESCRIPTION OF THE INVENTION

### Definitions

According to the present invention, “plastic parts” is understood to mean objects, the surface of which consists of a nonconducting plastic (polymer). These objects may consist entirely of one or more layer(s) of nonconducting polymer or they may be composed of metal and/or glassy materials and/or of a conducting polymer which are coated with one or more layer(s) of nonconducting polymer.

Furthermore, the term “support” or “frame” denotes a metal system which is suitable for making it possible to carry out at least some stages of a process for the metallization of a part or, preferably, simultaneously for a large number of parts.

The plastic parts used in the metallization process according to the present invention can comprise a nonconducting plastic chosen from thermoplastic polymers and thermosetting polymers, of natural or synthetic origin, chosen from epoxy resins, ABS (acrylonitrile/butadiene/styrene copolymer); a polyamide; polycarbonate; a polyester, such as poly(methyl methacrylate), poly(ethylene terephthalate) and poly(butylene terephthalate); a polyetherimide; poly(vinylidene fluoride); a polyetheretherketone; a polyolefin, such as polyethylene or polypropylene; poly(oxymethylene); polystyrene; poly(phenylene sulfide); and a blend of such polymers. In particular, the nonconducting plastic can be ABS, a polyamide, a polycarbonate or a blend of such polymers. More particularly, it consists of ABS or an ABS/polycarbonate blend. According to one embodiment of the invention, this plastic can comprise, in addition to the polymer or polymers constituting it, one or more organic and/or inorganic fillers intended in particular to reinforce it, such as silica, carbon fibers, glass fibers or aramid (in particular PPD-T) fibers. These parts are used in particular in the motor vehicle field but also as constituents of packagings for cosmetic products or bathroom components.

For its part, the support consists of or is covered with a plastic distinct from that forming the surface of the parts, generally formed of at least one polymer mixed with one or more plasticizers, in particular poly(vinyl chloride) or PVC.

In one embodiment, the plastic parts comprise regions which it is desired not to metallize. In this case, the inhibiting solution used according to the invention can be brought into contact with the parts after masking the portions to be preserved. In this embodiment, it is preferable to use a mask made of PVC or of another material exhibiting a greater affinity for the inhibiting solution than the plastic constituting the parts. In an alternative form, the surface of the parts may comprise at least two regions formed of different materials, which materials are obtained, for example, by multiple-injection molding. The difference in affinity of these materials for the inhibiting solution then results in a selective metallization of certain portions of the parts. It is thus possible to selectively metallize parts exhibiting a surface section formed of a plastic comprising ABS or an ABS/polycarbonate blend and another surface section comprising polycarbonate. The multi-injection molding process makes it possible to obtain parts exhibiting a transparent or translucent region and an opaque region, or to obtain a two-component part which is economically more advantageous than two components assembled mechanically. In another embodiment, the inhibiting solution is used according to the invention to prevent the metallization of the support of the plastic parts. In this case, it is brought into contact with the whole of the support, either before it is attached to the parts or once attached to the parts. This is because it has been observed that the inhibiting solution used according to the invention exhibited a greater affinity for the PVC constituting the support than for the polymers forming the surface of the parts to be metallized, so that it is pointless to treat the support separately. It is clearly understood that these two embodiments can be combined. In practice, it is preferable for the combination formed of the parts and of their support to be immersed in the inhibiting solution according to the invention. This results in an absence of metallization of the support and also possibly of the part portions to be preserved.

According to a preferred embodiment, the metallization process according to the invention comprises the combination of the following successive stages:

a) attaching the parts to be metallized to the support;

b) cleaning, in particular degreasing, the parts;

c) oxidizing the surface of said parts;

d) activating the surface of said parts;

e) optionally, chemical deposition of metal on said surface;

f) electrolytic deposition of metal.

In this case, the stage consisting in bringing the inhibiting solution into contact with the part and/or with the support is carried out before stage (c), optionally before stage (b), indeed even before stage (a). It is preferable for this stage to be carried out between the abovementioned stages (b) and (c). In an alternative form, they can be carried out during stages (a) and/or (b).

Stage (b) is a cleaning or degreasing stage well known to a person skilled in the art; it can in particular be carried out using a slightly alkaline bath.

Stage (c) above consists of an oxidizing treatment, using an oxidizing solution based in particular on nitric, hydrochloric or sulfuric acid, on a permanganate, on a chlorate, on a nitrate, on a peroxide, on Fenton's reagent, on hexavalent chromium and/or on ozone. It is preferable not to use hexavalent chromium in this stage. More preferably, the oxidizing solution is a sodium permanganate or potassium permanganate (advantageously sodium permanganate) solution which makes it possible to confer, at the surface of the support and parts, a fine roughness, generally of less than 0.1 μm, and to simultaneously create oxygen-based functional groups on the surface of the parts, advantageously chelating functional groups of carboxylic acid type. In addition, it is preferable for the oxidizing solution to exhibit an acidic pH, for example of less than 2, indeed even of less than 1. This stage can be carried out by dipping the support attached to the parts in a bath of oxidizing solution for a period of time ranging, for example, from 1 to 60 minutes, advantageously from 5 to 30 minutes. The temperature of the bath can be between 20 and 40° C.

In stage (d), particles of catalytic metal are created at the surface of the previously oxidized parts. These particles can be chosen from copper, silver, gold, nickel, platinum, palladium, iridium, rhodium or cobalt particles. According to a preferred embodiment of the invention, these particles can be created at the surface of the parts to be metallized by applying, to the surface, a solution containing one of the abovementioned metals, preferably copper or nickel, in the form of a salt with a tetrafluoroborate, sulfate, bromide, fluoride, iodide, nitrate, phosphate or chloride ion, for example, preferably with a sulfate or chloride ion. This solution preferably has a pH of greater than 7 and advantageously of between 9 and 11, preferably between 10 and 11. It is preferable for this pH to be achieved by addition of aqueous ammonia to the metal solution, rather than sodium hydroxide. In addition, according to a preferred embodiment of the invention, the metal solution does not contain an organic complexing agent. The parts to be metallized can be dipped in the metal solution for a period of time of one minute to one hour, for example of 10 to 20 minutes. On conclusion of this stage, the organic groups present at the surface of the parts as a result of the oxidizing treatment are bonded by chelation or complexing to the metal ions applied during stage (d).

In another embodiment of the invention, the surface of the parts to be metallized can be covered with a solution of metal colloid in stage (d). Use is advantageously made of a Pd/Sn colloid conventionally obtained by reduction of palladium chloride using tin(II) chloride in the presence of a strong acid, such as hydrochloric acid. In this case, stage (d) is generally broken down into an activation substage, described above, followed by an acceleration substage, which consists in immersing the part to be metallized, previously activated, in a bath, in particular of sulfuric acid, making it possible to oxidize the Sn(II) ions to give Sn(IV) ions and to release the adsorbed palladium particles.

On conclusion of stage (d), the surface of the parts to be metallized is covered with seeds of a catalytic metal and can thus be subjected optionally to the chemical deposition stage (e) or if not directly to the electrochemical deposition stage (f). In stage (e), the parts are generally immersed beforehand in a basic reducing solution containing at least one reducing agent, such as sodium borohydride, hydrazine, sodium hypophosphite or dimethylaminoborane. This solution can either contain, in addition, a salt of the metal to be deposited on the parts or be followed by a stage of application of a solution including this salt. It is generally a sulfate of a metal cation chosen from the silver, gold, cobalt, copper, iron, nickel, palladium and platinum ions, the nickel and copper ions being preferred in this invention. The solutions used in stage (e) can in addition comprise a complexing agent and/or a pH-regulating agent. It is preferable for the reduction stage to be carried out at highly basic pH, generally of between 11 and 13, and at a temperature of between 30 and 50° C.

On conclusion of stage (e), a metallized part is obtained, the surface metal layer of which can be thickened by electrolysis, in accordance with stage (f), following processes well known to a person skilled in the art. In an alternative form, stage (f) can be carried out directly after stage (d).

All the solutions employed in the process described above are aqueous solutions. In addition, stages (b), (c), (d) and (e) are carried out by dipping the parts and the support in baths comprising the reactants appropriate for carrying out each stage, although it is possible, in an alternative form, to apply the solutions described above by spraying.

The process described above can in addition comprise other intermediate stages, such as stages of rinsing the parts, in particular with water to which detergent and/or a base has optionally been added, or a stage of treatment using a reducing agent, in particular between stages (c) and (d), especially when the oxidizing treatment employs hexavalent chromium or an alkali metal permanganate.

As indicated above, an inhibiting solution is applied to the support and optionally to the parts upstream of stage (c). This solution comprises at least one metallization inhibitor chosen from sulfur-based compounds and specifically from sodium sulfite, thiourea, thiols, thioethers, compounds carrying at least one thiol and/or one thiazolyl group and their mixtures. Preference is given, among this list, to organic sulfur compounds and more particularly thiols, thioethers and compounds carrying at least one thiol and/or one thiazolyl group. The metallization inhibitor can optionally be combined with at least one additional inhibitor chosen from: oxalic acid, a lead salt, a cadmium salt, a tin salt, an aluminum salt, urea, thallium nitrate, 4-nitrobenzenediazonium tetrafluoroborate and 4-aminobenzoic acid. The additional inhibitors in the form of salts can be formed of organic or inorganic salts, in particular sulfate, nitrate, oxalate or acetate, without this list being limiting. Preference is given, among the abovementioned metallization inhibitors, to the use of thiols and thioethers, in particular aromatic heterocyclic thioethers, such as mercaptobenzothiazole. The inhibiting solution advantageously includes a concentration of inhibitor representing from 0.01 g/l (0.0001% w) to 10 g/l (0.1% w), for example from 0.01 g/l (0.0001% w) to 10 g/l (0.1% w), by weight, with respect to the total volume of the composition.

In one embodiment, the solution comprising the metallization inhibitor has a pH of between 0.5 and 6 and preferably between 1 and 3. Said solution thus preferably comprises a compound which regulates the pH at this value, which compound is advantageously chosen from phosphoric acid, hydrochloric acid and sulfuric acid.

In one embodiment, the inhibiting solution additionally comprises at least one viscosifying agent which can in particular be chosen from hydrocolloids, such as cellulose derivatives, in particular carboxymethylcellulose or hydroxypropyl methylcellulose; gelatin; algal extracts, such as agar, alginates and carrageenans; synthetic polymers, such as poly(vinyl alcohol), acrylic and methacrylic acid polyesters, including poly(hydroxyethyl methacrylate), and salts of poly(acrylic acid) and of poly(methacrylic acid); starch and its derivatives; galactomannans, such as guar gum; and their mixtures, without this list being limiting.

The invention will be better understood in the light of the following examples, which are given for illustrative purposes only and do not have the aim of limiting the scope of this invention.

### EXAMPLES

### Example 1

### Metallization Process using Chromium (Palladium-Free Activation)

A sample to be metallized is prepared by attaching a control part made of ABS to a conventional support made of PVC. After degreasing, the sample (support+part) is placed for 20 minutes in a bath containing 40 g/l of mercaptobenzothiazole, 100 ml/l of sulfuric acid (95%) and 25 g/l of carboxymethylcellulose. The bath is thermally regulated at 40° C. The sample is subsequently dipped in a satin-finishing bath brought to 65° C., for 10 min, the bath comprising 400 g/l of sulfuric acid and 400 g/l of chromic acid, and then in a 10 g/l hydrazine solution. It is subsequently immersed in a catalysis bath maintained at 30° C., including a Pd/Sn colloid in an amount sufficient to obtain a palladium concentration of 30 ppm in the bath, and then in an acceleration bath at 50° C., based on sulfuric acid. The chemical deposition of nickel is subsequently carried out in an aqueous solution including 10 g/l of nickel sulfate, 10 g/l of sodium hypophosphite, 50 g/l of 33% aqueous ammonia solution, until a deposit of 0.3 μm is obtained on the surface of the part.

Metallization of the support is not observed.

### Example 2

### Chromium-Free Metallization Process (Palladium-Free Activation)

A part made of ABS and also a two-material part exhibiting both ABS/PC regions and PC regions are attached to a support made of plasticized PVC. After degreasing, the assembly is dipped in a solution containing 8 g/l of mercaptobenzothiazole, 100 ml/l of phosphoric acid (85%) and 25 g/l of carboxymethylcellulose for 15 minutes. The bath is regulated at 40° C. After rinsing, the assembly is immersed for 10 minutes in a satin-finishing bath comprising sodium permanganate and phosphoric acid. After rinsing, the assembly is dipped for 5 minutes in an activation bath comprising copper sulfate pentahydrate and aqueous ammonia and then, after fresh rinsing, in a reducing solution containing sodium borohydride and sodium hydroxide. In order to finish, the assembly is immersed in a chemical copper plating bath, comprising copper, EDTA, sodium hydroxide and formaldehyde (Circuposit 3350-1 from Rohm & Haas).

On conclusion of this process, no trace of metallization is observed on the support or on the region made of polycarbonate of the co-injection molded parts, whereas the reference part made of ABS and the regions made of ABS/PC of the two-material parts are completely metallized.

### Example 3

### Chromium-Free Metallization Process (Activation with Palladium)

A part made of ABS and also a two-material part exhibiting both ABS/PC regions and PC regions are attached to a support made of plasticized PVC. After degreasing, the assembly is dipped in a solution containing 12 g/l of (2-chloro-1,3-thiazol-5-yl)methanol, 100 ml/l of phosphoric acid (85%) and 25 g/l of carboxymethylcellulose for 15 minutes. The bath is regulated at 40° C. After rinsing, the assembly is immersed for 10 minutes in a satin-finishing bath comprising sodium permanganate and phosphoric acid. After rinsing, the assembly is dipped for 3 minutes in a bath for activating with palladium comprising 250 ml/l of hydrochloric acid and 38 ml/l of mixture of palladium and of tin chloride (Catalyst 9F from Rohm & Haas). After fresh rinsing, the assembly is immersed in an “acceleration” bath based on sulfuric acid.

On conclusion of this process, no trace of metallization is observed on the support or on the region made of polycarbonate of the co-injection molded parts, whereas the reference part made of ABS and the regions made of ABS/PC of the two-material parts are completely metallized.

### Example 4 (Comparative)

### Chromium-Free Metallization Process (Palladium-Free Activation)

A part made of ABS and also a two-material part exhibiting both ABS/PC regions and PC regions are attached to a support made of plasticized PVC. After degreasing, the assembly is immersed for 10 minutes in a satin-finishing bath comprising sodium permanganate and phosphoric acid. After rinsing, the assembly is dipped for 5 minutes in an activation bath comprising copper sulfate pentahydrate and aqueous ammonia and then, after fresh rinsing, in a reducing solution containing sodium borohydride and sodium hydroxide. In order to finish, the assembly is immersed in a chemical copper plating bath, comprising copper, EDTA, sodium hydroxide and formaldehyde (Circuposit 3350-1 from Rohm & Haas).

On conclusion of this process, it is found that a portion of the support is metallized and traces of metallization are also observed on the regions made of polycarbonate of the two-material parts. The reference parts and the regions made of ABS/PC of the two-material parts are completely metallized.

### Example 5 (Comparative)

### Chromium-Free Metallization Process (Activation with Palladium)

A part made of ABS and also a two-material part exhibiting both ABS/PC regions and PC regions are attached to a support made of plasticized PVC. After degreasing, the assembly is immersed for 10 minutes in a satin-finishing bath comprising sodium permanganate and phosphoric acid. After rinsing, the assembly is dipped for 3 minutes in a bath for activating with palladium comprising 250 ml/l of hydrochloric acid and 38 ml/l of mixture of palladium and of tin chloride (Catalyst 9F from Rohm & Haas). After fresh rinsing, the assembly is immersed in an “acceleration” bath based on sulfuric acid.

On conclusion of this process, it is found that the assembly of the support and of the parts is completely metallized, including the regions made of polycarbonate of the two-material parts, which are not supposed to metallize.

### Example 6

### Study of Different Metallization Inhibitors

The protocol described in example 2 was reproduced while modifying the nature of the metallization inhibitor. The results obtained for the different inhibitors tested are collated in the table below.

| | | Concen- | | | Absence of |
|---|---|---|---|---|---|
| Exam- | | tration | Metallization part | | metallization |
| ple | Inhibitor | (g/l) | ABS/PC | PC | on support |
| Ex. 6A | (Thiazol-2- | 5 | Yes | No | OK |
| | yl)acetic acid | | | | |
| Ex. 6B | 2-Mercaptobenzo- | 4 | Yes | No | OK |
| | thiazole | | | | |
| Ex. 6C | 5-Chloro-2- | 6 | Yes | No | OK |
| | mercapto- | | | | |
| | benzothiazole | | | | |
| Ex. 6D | 2-Mercapto-3- | 11 | Yes | No | OK |
| | butanol | | | | |
| Ex. 6E | 2-(Thiazol-2- | 8 | Yes | No | OK |
| | yl)ethyl-amine | | | | |
| | hydrochloride | | | | |
| Ex. 6F | 4-Phenylthiazole- | 23 | Yes | No | OK |
| | 2-thiol | | | | |

As emerges from the table above, the metallization inhibitors according to the invention all make it possible to selectively metallize the parts and portions of parts to be metallized and to preserve the support and the portions of parts to be optionally preserved.

1. A method for preventing the metallization of a support of at least one plastic part subjected to a metallization process in which the support is formed of or covered with a plastic distinct from that forming a surface of the parts and formed of poly(vinyl chloride) mixed with one or more plasticizers, said method, comprising the successive stages:
of oxidation of the surface of said part,
of activation of the oxidized surface by creation of particles of catalytic metal at the surface of the parts, and
of chemical and/or electrochemical deposition of metal on the activated surface, characterized in that the method further comprises a stage in which said support, before said oxidation stage, is brought into contact with an inhibiting solution comprising at least one metallization inhibitor chosen from sodium sulfite, thiourea, thiols, thioethers, compounds carrying at least one thiol and/or one thiazolyl group and their mixtures.

2. The method as claimed in claim 1, characterized in that the inhibiting solution has a pH of between 0.5 and 6.

3. The method as claimed in claim 2, characterized in that the inhibiting solution additionally comprises a pH regulator.

4. The method as claimed in claim 3, characterized in that the pH regulator is chosen from sulfuric acid, hydrochloric acid and phosphoric acid.

5. The method as claimed in claim 1, characterized in that the inhibiting solution additionally comprises a viscosifying agent.

6. The method as claimed in claim 5, characterized in that the viscosifying agent is chosen from cellulose derivatives; gelatin; algal extracts; synthetic polymers; starch and its derivatives; galactomannans; and their mixtures.

7. A process for the selective metallization of a plastic part combined with a support, comprising the successive stages:
of oxidation of a surface of said part without using hexavalent chromium,
of activation of the oxidized surface by creation of particles of catalytic metal at the surface of the parts, and
of chemical and/or electrochemical deposition of metal on the activated surface, said process comprising a stage in which said part, before said oxidation stage, is brought into contact with an inhibiting solution comprising at least one metallization inhibitor chosen from sodium sulfite, thiourea, thiols, thioethers, compounds carrying at least one thiol and/or one thiazolyl group and their mixtures, in which either the inhibiting solution is brought into contact with the parts after masking portions to be preserved using a material exhibiting a greater affinity for the inhibiting solution than the plastic forming the parts or the surface of the parts comprises at least two regions formed of different materials.

8. (canceled)

9. (canceled)

10. The method as claimed in claim 2, characterized in that the inhibiting solution additionally comprises a viscosifying agent.

11. The method as claimed in claim 10, characterized in that the viscosifying agent is chosen from cellulose derivatives; gelatin; algal extracts; synthetic polymers; starch and its derivatives; galactomannans; and their mixtures.

12. The method as claimed in claim 3, characterized in that the inhibiting solution additionally comprises a viscosifying agent.

13. The method as claimed in claim 12, characterized in that the viscosifying agent is chosen from cellulose derivatives; gelatin; algal extracts; synthetic polymers; starch and its derivatives; galactomannans; and their mixtures.

14. The method as claimed in claim 4, characterized in that the inhibiting solution additionally comprises a viscosifying agent.

15. The method as claimed in claim 14, characterized in that the viscosifying agent is chosen from cellulose derivatives; gelatin; algal extracts; synthetic polymers; starch and its derivatives; galactomannans; and their mixtures.

16. The method as claimed in claim 7 wherein the at least two regions are obtained by multiple-injection molding.
